(19) United States
(12) Patent Application Publication
(10) Pub. No.: US 2026/0012475 A1
(43) Pub. Date: Jan. 8, 2026

(54) RISK EVALUATION DEVICE, RISK EVALUATION METHOD, AND RISK EVALUATION PROGRAM

(71) Applicant: Nippon Telegraph and Telephone Corporation, Tokyo (JP)

(72) Inventor: Ryohei SATO, Musashino-shi, Tokyo (JP)

(21) Appl. No.: 18/873,542

(22) PCT Filed: Jun. 21, 2022
(86) PCT No.: PCT/JP2022/024754

§ 371 Date: Dec. 10, 2024

(51) Int. Cl. H04L 9/40

(52) U.S. Cl. CPC H04L 63/1433

(57) ABSTRACT

A risk evaluation device (20) includes: a graph processing unit (23) that creates a state transition diagram of a continuous-time Markov chain that is a data structure including each node and each edge of a BAG and in which an obtained transition rate is applied to each edge instead of an exploit success probability of each edge; and a graph analysis unit (24) that calculates a risk probability of each node that changes with an elapsed time t from when an attacker has started an attack by performing a Markov analysis process on the basis of the state transition diagram created by the graph processing unit (23) and the elapsed time t.

### TECHNICAL FIELD

The present invention relates to a risk evaluation device, a risk evaluation method, and a risk evaluation program.

### BACKGROUND ART

A network system is exposed to various cyberattack threats. For accurate and efficient risk management, risk assessment is used to accurately identify a security risk of the system and quantitatively analyze and evaluate the identified security risk.

A cyberattack on the network system is generally implemented by sequentially exploiting a plurality of vulnerabilities inherent in the system. Therefore, in the risk assessment, it is essential to identify, analyze, and evaluate a risk in consideration of the vulnerabilities inherent in the system and dependencies therebetween.

Non Patent Literature 1 discloses a security risk assessment method using a Bayesian attack graph (BAG). The method uses a BAG to express probabilistic dependencies between vulnerabilities inherent in a network system and comprehensively describes paths (attack procedures) that can be taken when an attacker attacks an information asset in the system. That is, the use of the BAG makes it is possible to mechanically and quantitatively calculate a probability of transition to each system state while considering the dependencies between the vulnerabilities. Hereinafter, details of the BAG will be described,

FIG. 8 is a graph showing an example of a conventional BAG.

The BAG is a Bayesian network (BN) for expressing probabilistic dependencies between vulnerabilities inherent in a network system. The BAG comprehensively describes paths (attack procedures) that can be taken when an attacker attacks an information asset in the system.

Each node of the BAG, such as S₀, S₁, . . . , and S₂₈, indicates a system state.

A probability that the system state transitions, such as P_{0,1}, P_{0,2}, . . . or P_{27,28}, that is, an exploit success probability of the corresponding vulnerability is applied to an edge of the BAG connecting the nodes of the BAG. Subscripts of the exploit success probability (e.g. P_{0,1}) are a combination of the number of a system state of a transition source (e.g. S₀) and the number of a system state of a transition destination (e.g. S₁).

Here, the system state is, for example, a “state in which an administrator privilege of a specific information asset (e.g. host) has been transferred to the attacker”, and the transition of the system state corresponds to “(successful) exploitation of the vulnerability”.

For example, the following nodes of the BAG are connected by edges.
First node “a state in which a remote attacker starts an attack”
Second node “a state in which a host having an IP address “196.216.0.128” and having activated Open SSH is attacked,”
Third node “a state in which authentication of a host can be illegally passed (authentication bypass)”

Here, it is assumed that the exploit success probability of “708” is applied to an edge from the second node to the third node. The “exploit success probability” indicates a probability that the attacker carries out a cyberattack exploiting a vulnerability inherent in Open SSH operating in the host and can illegally pass authentication of the host due to the successful attack.

As described above, the exploit success probability is a probability value applied to each edge of the input BAG in advance by an administrator or the like. The exploit success probability is a probability that the attacker succeeds in exploiting a vulnerability and is described in a conditional probability table (CPT) of each node.

Further, the node of the BAG includes a node indicating a state that the administrator recognizes as a security risk, such as “a state in which an administrator privilege of a specific information asset such as a host that manages confidential information has been transferred to the attacker”. A “risk probability” is a probability of such a risk occurring, and the risk probability is a probability value calculated by a BAG analysis process in consideration of dependencies between the exploit success probabilities of the BAG.

### CITATION LIST

### Non Patent Literature

Non Patent Literature 1: N. Poolsappasit, R. Dewri and I. Ray, “Dynamic Security Risk Management Using Bayesian Attack Graphs” IEEE Transactions on Dependable and Secure Computing, vol. 9, no. 1, pp. 61-74, 2012.

### SUMMARY OF INVENTION

### Technical Problem

An environment surrounding a network system and a characteristic and magnitude of a risk possessed by the network system change from moment to moment, and thus risk assessment needs to be performed dynamically, quickly, and accurately. That is, it is necessary to perform the assessment in consideration of a temporal change in the risk. In particular, a temporal change required for a vulnerability attack is an important factor to be considered in the risk assessment.

For example, a certain amount of time is required from when an attacker starts attacking a network system to when the attacker achieves a goal (i.e. a state transitions to a desired system state described in a BAG). Therefore, the risk is supposed to increase as time elapses from the start of the attack.

However, in a conventional method of analyzing a BAG such as Non Patent Literature 1, the risk probability is calculated without considering a lapse of time, Therefore, it may be impossible to analyze how the risk increases after the attack is started, and the assessment may lack accuracy and reality.

For example, in a case where risk treatment is performed within two hours from a certain point of time, a risk to be treated needs to be basically selected and prioritized while predicting and referring to a risk probability after two hours.

In view of this, a main object of the present invention is to perform risk evaluation in consideration of a temporal change in a risk.

### Solution to Problem

In order to solve the above problems, a risk evaluation device of the present invention has the following features.

The present invention includes:
a BAG acquisition unit that acquires a BAG that is a graph including, as components, a node indicating a state of a network system to be subjected to risk evaluation and an edge indicating a state transition by connecting the nodes and in which an exploit success probability that is a probability that an attacker succeeds in exploiting a vulnerability is applied to each edge;
a graph processing unit that obtains a transition rate indicating a speed at which the attacker succeeds in exploiting the vulnerability by using the exploit success probability of the BAG and a limit time required for attacking the vulnerability and creates a state transition diagram of a continuous-time Markov chain that is a data structure including each node and each edge of the BAG and in which the obtained transition rate is applied to each edge instead of the exploit success probability of each edge;
a graph analysis unit that calculates a risk probability of each node that changes with an elapsed time from when the attacker has started the attack by performing a Markov analysis process on the basis of the state transition diagram created by the graph processing unit and the elapsed time; and
an output unit that outputs the calculated risk probability.

### Advantageous Effects of Invention

According to the present invention, it is possible to perform risk evaluation in consideration of a temporal change in a risk.

### BRIEF DESCRIPTION OF DRAWINGS

FIG. 1 is a configuration diagram of a risk evaluation device in Example 1.

FIG. 2 is a hardware configuration diagram of the risk evaluation device in Example 1.

FIG. 3 is a flowchart showing processing in which a graph processing unit in Example 1 generates a state transition diagram.

FIG. 4 is a graph showing a method of calculating a parameter λ in Example 1,

FIG. 5 is a graph showing an example of the state transition diagram generated by the processing of FIG. 3 in Example 1.

FIG. 6 is a flowchart showing processing in which a graph processing unit in Example 2 generates a state transition diagram.

FIG. 7 is a graph showing an example of the state transition diagram generated by the processing of FIG. 6 in Example 2,

FIG. 8 is a graph showing an example of a conventional BAG.

### DESCRIPTION OF EMBODIMENTS

Hereinafter, examples of the present invention will be described with reference to the drawings.

### Example 1

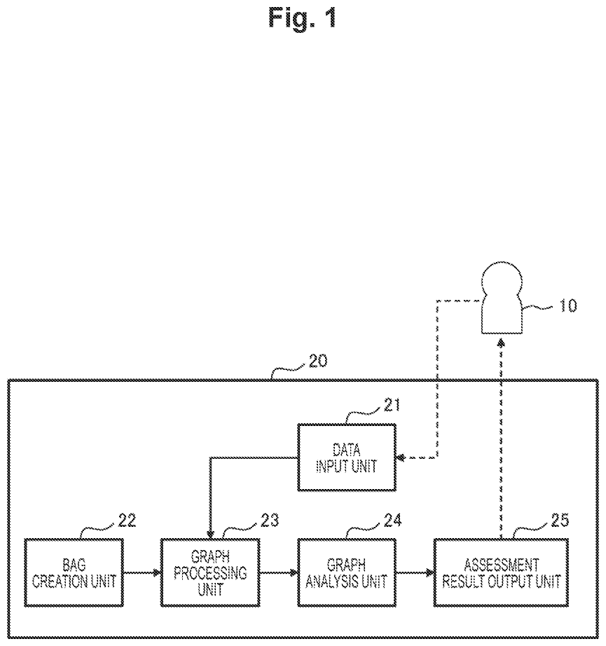

FIG. 1 is a configuration diagram of a risk evaluation device 20 in Example 1.

A main difference between a method of the risk evaluation device 20 and a method using a conventional BAG such as Non Patent Literature 1 will be described.

First, as a data structure to be analyzed, a difference in a graph showing probabilistic dependencies between system states will be described.

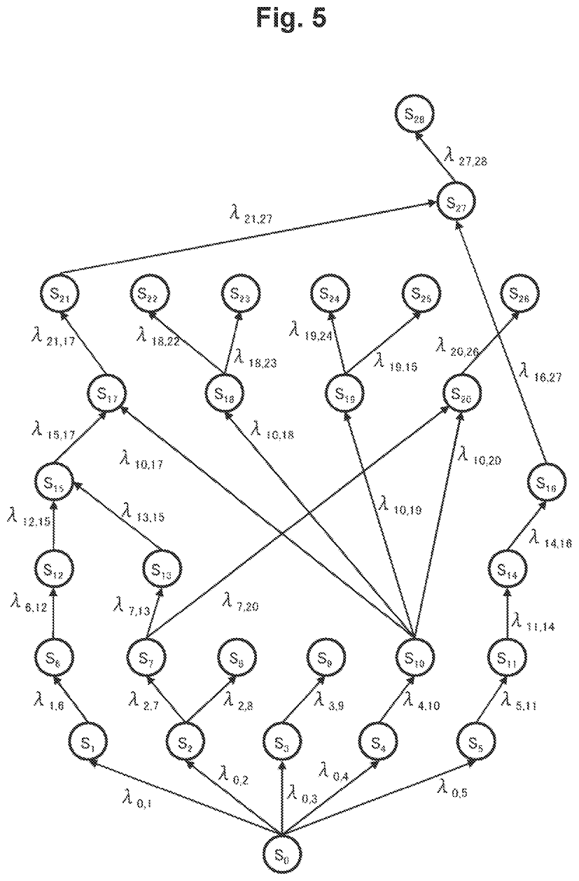

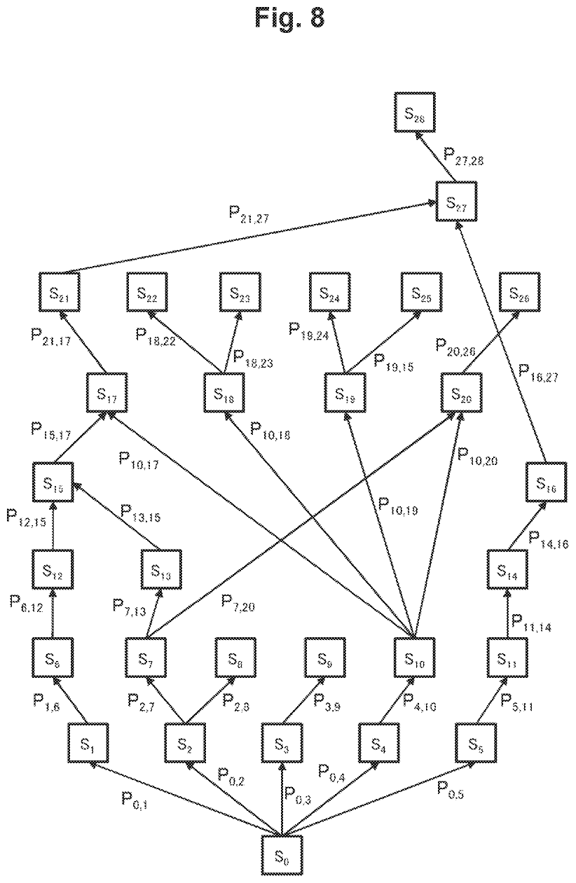

A BAG as in FIG. 8 has been conventionally used, and an exploit success probability is applied to an edge of the BAG. The risk evaluation device 20 in Example 1 uses a state transition diagram of a continuous-time Markov chain (data showing a state transition, which will be described with reference to FIG. 5) instead of the BAG.

The continuous-time Markov chain is a kind of stochastic process having a Markov property and defined on a continuous time axis. Here, the stochastic process is a random variable that changes depending on a lapse of time. In the continuous-time Markov chain, what kind of probabilistic dependency a Markov chain has is defined by the state transition diagram, thereby enabling specific Markov analysis.

The state transition diagram and the BAG have a common node and edge configuration (graph structure), but a “transition rate” calculated by the risk evaluation device 20 is applied to an edge of the state transition diagram.

The “transition rate” is a parameter indicating a speed at which an attacker succeeds in exploiting a vulnerability (i.e. a speed of a state transition) and is defined as a “parameter A” applied to each edge of the state transition diagram in the present specification.

Next, a difference in an analysis process will be described.

A risk probability has been conventionally calculated by a BAG analysis process in consideration of dependencies between the exploit success probabilities of the BAG. The risk probability is a parameter in which a temporal change in a risk is not considered. The risk evaluation device 20 in Example 1 calculates the risk probability by performing a Markov analysis process instead of the BAG analysis process.

The Markov analysis process is a process of obtaining a state probability of each state in the state transition diagram on the basis of the state transition diagram and an elapsed time t given by a system administrator 10 or the like. The state probability is a probability that a system transitions to each state (node) at a certain time, and a state probability of a state defined as a security risk is defined as the risk probability.

Here, the “elapsed time t” is an elapsed time from when the attacker has started an attack and is a parameter designated by the administrator or the like to obtain the risk probability at a point of time when the elapsed time t has elapsed. As the elapsed time t, for example, 60 minutes, 120 minutes, 180 minutes, or the like is designated. This makes it possible to observe a change in the risk probability per 60 minutes.

Further, the “state probability” is the risk probability obtained by the Markov analysis process in consideration of the elapsed time t in each state of the state transition diagram recognized as a security risk by the administrator. Therefore, it is possible to perform risk evaluation in consideration of the temporal change in the risk.

The risk evaluation device 20 includes a data input unit 21, a BAG creation unit 22, a graph processing unit 23, a graph analysis unit 24, and an assessment result output unit 25.

Parameters (e.g. elapsed time t and average duration T described later) required for the Markov analysis process are input to the data input unit 21 by the system administrator 10 or the like.

The BAG creation unit 22 creates a BAG by using the technology disclosed in Non Patent Literature 1 or the like for a network system to be subjected to risk assessment. The BAG is a graph including, as components, a node indicating a state of the network system to be subjected to risk evaluation and an edge indicating a state transition by connecting the nodes, and an exploit success probability that is a probability that an attacker succeeds in exploiting a vulnerability is applied to each edge.

Alternatively, the BAG creation unit 22 may be configured as a BAG acquisition unit that acquires a BAG already stored in a storage device.

The graph processing unit 23 describes attack paths (attack procedures) that can be taken by the attacker as a state transition diagram of a continuous-time Markov chain on the basis of the BAG obtained from the BAG creation unit 22 and the parameters obtained from the data input unit 21.

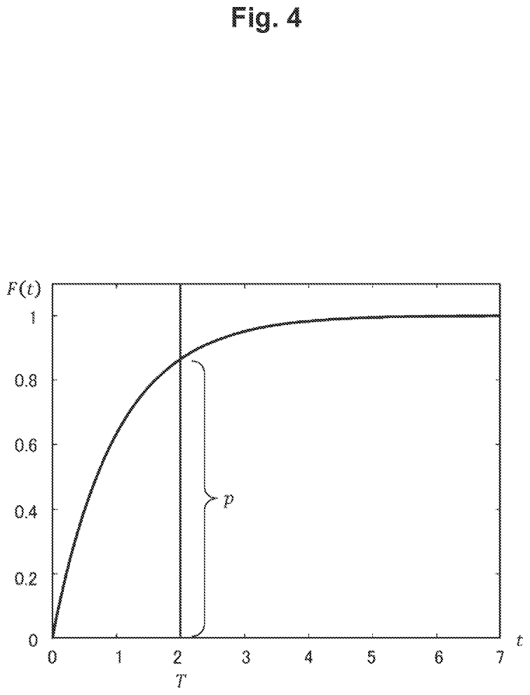

That is, the graph processing unit 23 obtains a transition rate indicating a speed at which the attacker succeeds in exploiting the vulnerability by using the exploit success probability of the BAG and a limit time required for attacking the vulnerability (details are shown in FIG. 4) and creates a state transition diagram of a continuous-time Markov chain that is a data structure including each node and each edge of the BAG and in which the obtained transition rate is applied to each edge instead of the exploit success probability of each edge.

The graph analysis unit 24 performs probability calculation of the Markov analysis process on the basis of the state transition diagram created by the graph processing unit 23 and the input elapsed time t, thereby calculating the risk probability that changes with the elapsed time t on the basis of an exponential distribution.

That is, the graph analysis unit 24 calculates the risk probability of each node that changes with the elapsed time t by performing the Markov analysis process on the basis of the state transition diagram created by the graph processing unit 23 and the elapsed time t from when the attacker has started the attack.

The assessment result output unit 25 outputs the risk probability that is the calculation result of the graph analysis unit 24 to the system administrator 10 or the like.

Note that the following (Premise 1) to (Premise 3) are provided for easy understanding of the description of the Markov analysis process performed by the graph processing unit 23. However, the risk evaluation device 20 in Example 1 can be applied without being limited to the following premises.

(Premise 1) A time from when the attacker starts an attack (an attempt to exploit) on a certain vulnerability to when the attacker succeeds in the attack is assumed to be completely random and follow an exponential distribution.

(Premise 2) An average value of time spent by the attacker to carry out one vulnerability attack (corresponding to one state transition in the BAG) “average duration T of unit attack” is assumed to be given in advance as a value for each edge or a uniform value for all edges. More specifically, the average duration T in which, in a case where one of an unspecified large number of attackers cannot exploit a certain vulnerability at a point of time when the average duration T has elapsed from when the attacker has started attacking the vulnerability, the attacker is expected to give up the attack is assumed to be given.

Note that the unspecified large number of attackers vary in attack skills, and thus duration from the start of attack on a certain vulnerability to the end of the attack also varies. Therefore, the average duration T of a plurality of attackers is used. The average duration T is a parameter input from the data input unit 21 by the system administrator 10 or the like.

(Premise 3) At this time, a probability value applied to each edge of the BAG, that is, an exploit success probability of a vulnerability corresponding to each edge is regarded as a probability that the attacker succeeds in exploiting a vulnerability attack (i.e. succeeds in state transition) at a point of time when the average duration T has elapsed from the start of the vulnerability attack.

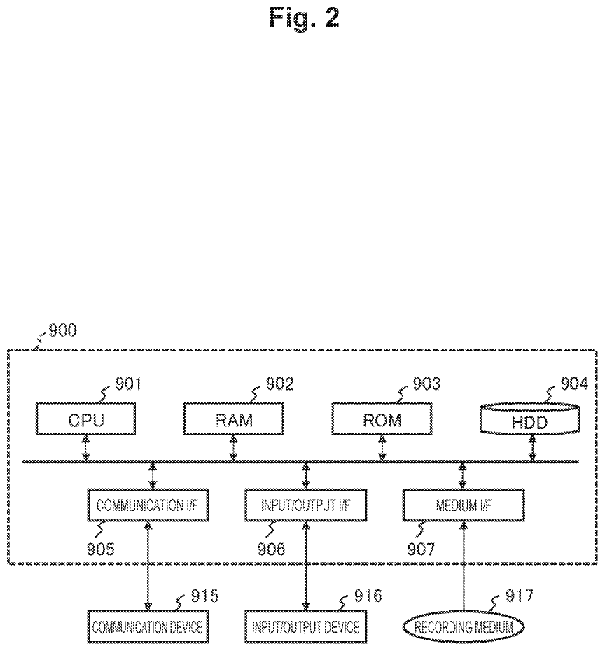

FIG. 2 is a hardware configuration diagram of the risk evaluation device 20.

Each device of a calculation result protection system 1 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. The CPU 901 controls each unit by executing a program (also referred to as an application or an app as an abbreviation therefor) read into the RAM 902. The program may be distributed via a communication line or distributed by being recorded in the recording medium 917 such as a CD-ROM.

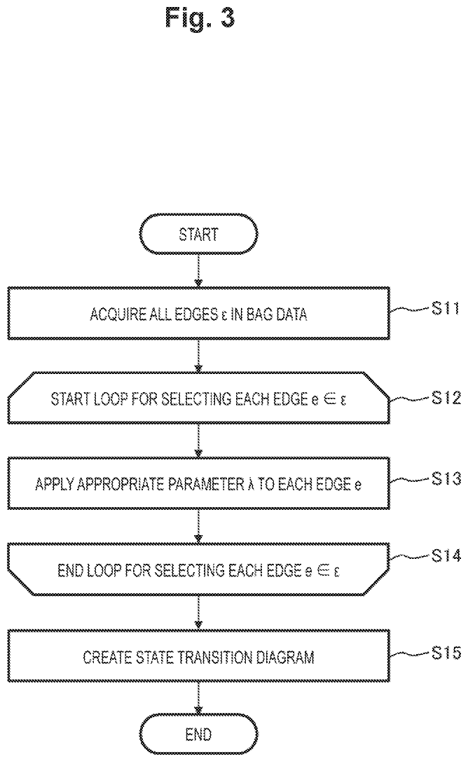

FIG. 3 is a flowchart showing processing in which the graph processing unit 23 in Example 1 generates a state transition diagram.

The graph processing unit 23 acquires a set e of all edges in a BAG obtained from the BAG creation unit 22 (S11).

The graph processing unit 23 performs a loop for each edge e E g acquired in S11 (S12 to S14). In the loop, the graph processing unit 23 calculates the parameter A indicating an appropriate transition rate to be applied to each edge e and applies the parameter A to each edge e (S13).

As a result of performing the loop in S12 to S14, the graph processing unit 23 creates a state transition diagram in which the parameter A is applied to each edge (S15).

By the processing in FIG. 3, the graph processing unit 23 describes a transition of the system state (node) in the BAG as a continuous-time Markov chain by using the BAG obtained from the BAG creation unit 22 and the average duration T of the unit attack (the parameter used in S13; details are shown in FIG. 4) obtained from the data input unit 21.

FIG. 4 is a graph showing a method of calculating the parameter λ in S13.

When a reciprocal of an average time from when the attacker starts attacking a certain vulnerability to when the attacker succeeds in exploiting the vulnerability is set to the parameter λ, it is possible to describe a Markov chain in which an appropriate parameter λ is set. Therefore, the graph processing unit 23 calculates the parameter λ as follows.

First, at a point of time when a time t has elapsed from when the attacker has started attacking the vulnerability, a probability of success in the exploit is equivalent to a cumulative distribution function F (t) of the exponential distribution (Mathematical Expression 1). Note that, at this time, a value of the parameter λ is unknown.

$$F ( t ) = 1 - {e}^{- λ t} \qquad ( Mathematical Expression 1 )$$

When the probability value applied to the edge of the BAG is denoted by p, the probability that the attacker succeeds in exploiting the vulnerability attack at any point (at a point of time when the average duration T serving as the limit time required for the attack has elapsed) after the attacker has started the vulnerability attack can be regarded as p. Therefore, (Mathematical Expression 2) holds.

$$F ( t ) = 1 - {e}^{- λ t} = p \qquad ( Mathematical Expression 2 )$$

When an equation of (Mathematical Expression 2) is solved, an appropriate parameter λ is obtained by (Mathematical Expression 3),

$$λ = - ( ln ( 1 - p ) ) / T \qquad ( Mathematical Expression 3 )$$

Note that an arbitrary parameter λ may be applied to each edge by the system administrator 10 or the like without depending on the calculation method described with reference to FIG. 4.

FIG. 5 is a graph showing an example of the state transition diagram generated by the processing in FIG. 3.

The graph processing unit 23 generates the state transition diagram in FIG. 5 by performing the processing in the flowchart of FIG. 3 on the BAG of FIG. 8. In the state transition diagram, a shape of the graph basically does not change from the BAG of FIG. 8, and the parameter λ is applied to each edge.

The graph analysis unit 24 performs risk assessment by calculating a transition time between states and a state probability (also including a risk probability) of each state on the basis of the state transition diagram created by the graph processing unit 23 and issues a result of performing the assessment to the assessment result output unit 25, Here, in a case where the state transition diagram is uniquely given, the risk assessment calculation method is also uniquely determined. Hereinafter, a procedure of the calculation method will be exemplified.

(Procedure 1) The system administrator 10 or the like arbitrarily determines a probability vector of a Markov chain in an initial state (elapsed time t=0) (hereinafter, “initial state probability vector”). Assuming that a state probability of each node in the initial state is defined as an initial state probability, the initial state probability vector is a set of the initial state probabilities of the nodes. For example, in the state transition diagram of FIG. 5, the initial state probability vector is determined such that the initial state probability of a state S₀ corresponding to a state in which a remote attacker starts an attack is defined as 1, whereas the initial state probabilities of the other nodes are defined as 0.

(Procedure 2) The graph analysis unit 24 obtains a (transient) state probability of each state at the time t on the basis of the state transition diagram and the initial state probability vector. Here, the system administrator 10 defines a state S15 in which the attacker takes a user access privilege of each user terminal having an IP address “10.0.0.0-127” as a security risk, At this time, the graph analysis unit 24 obtains a state probability φ₁₅(t) of the state S15 at the elapsed time t from when the attacker has started attacking the system.

(Procedure 3) The graph analysis unit 24 obtains an average time (average transition time) of each attacker to transition to each state on the basis of the state transition diagram and the initial state probability vector. For example, when the graph analysis unit 24 obtains an average time to transition to the state S₁₅, it is possible to obtain an average time from when the attacker starts attacking the system to when the attacker takes the user access privilege of each user terminal having the IP address “10.0.0.0-127”.

Note that (Procedure 1) is essential, but whether to perform (Procedure 2) and (Procedure 3) may be arbitrarily determined. For example, in a case where the risk assessment is performed by using only the average transition time without using the state probability, (Procedure 2) does not need to be performed.

The assessment result output unit 25 provides the system administrator 10 or the like with the assessment result such as various probability values and average transition times received from the graph analysis unit 24. Further, the assessment result output unit 25 may provide a value of the assessment result (risk probability) after processing the result by the following display processing such that the system administrator 10 or the like can more easily understand the value,
A state in which the risk probability exceeds a threshold in threshold determination and a probability value thereof are displayed as an alert.
States are sorted and displayed in descending order of the risk probability or in ascending order of the average transition time (i.e. in descending order of a degree of risk).

Therefore, the system administrator 10 or the like can refer to the assessment result to take measures such as preferentially patching a vulnerability having a higher risk.

### Example 2

Hereinafter, Example 2 will be described.

In Example 2, components other than the graph processing unit 23 are the same as those in Example 1 including the system configuration of the risk evaluation device 20. The graph processing unit 23 in Example 1 creates a state transition diagram of a Markov chain by adopting nodes and edges of a BAG as they are and calculating and applying only the parameters λ of the edges. Meanwhile, in Example 2, the following problems and additional processing for solving the problems are further performed.

(Problem 1) A state probability φ₁ (t) of a state S₁ at the time t, which is obtained by the graph analysis unit 24 in Example 1, indicates a “probability that a system is in the state S₁ exactly at the time t”. Therefore, a probability of transitioning to a state S; after the state S₁ (passing through the state S₁) is not reflected therein. That is, (Problem 1) is to create a state transition diagram for obtaining a “probability of transitioning to the state S₁ before the time t” also in consideration of the probability of passing through the state S₁.

(Problem 2) In a case where there is a possibility that a certain state transitions to a plurality of other states (in a case where a plurality of edges comes out from a certain state), the Markov analysis process by the graph analysis unit 24 is performed on the premise that the certain state transitions to only one state probabilistically selected therefrom. Therefore, the analysis is based on the premise that, in a case where there is a plurality of options (branches) that can be taken by the attacker, only one of the options is selected. However, the attacker normally carries out an attack while trying various options, and thus the analysis lacks reality. Therefore, (Problem 2) is to enable analysis on the assumption that the attacker simultaneously selects a plurality of paths.

In Example 2, in order to solve (Problem 1) and (Problem 2), the graph processing unit 23 additionally performs the following (Solution 1) and (Solution 2).

(Solution 1) The graph processing unit 23 determines a target node Sᵢ to be analyzed and creates a state transition diagram capable of analyzing the target node as an absorbing state. Therefore, for (Problem 1), it is possible to calculate the “probability of transitioning to the state Sᵢ before the time t”.

(Solution 2) The graph processing unit 23 creates a state transition diagram excluding edges other than a path that can reach the target node from a node whose initial state probability is set to non-zero (hereinafter, “initial node”). Therefore, for (Problem 2), it is possible to enable analysis on the assumption that the attacker simultaneously selects a plurality of paths. That is, all branches from the initial node are aggregated into one target node, and thus a state probability (i.e. risk probability) of the target node, which is similar to a state probability in a case where all the branches to the target node are traced simultaneously in parallel, is calculated.

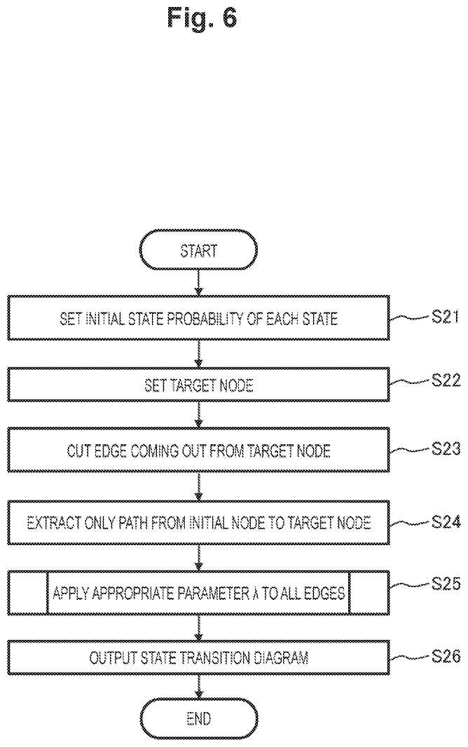

FIG. 6 is a flowchart showing processing in which the graph processing unit 23 in Example 2 generates a state transition diagram.

The graph processing unit 23 sets an initial state probability (sets an initial state vector) of each state of a state transition diagram input from the data input unit 21 by the system administrator 10 or the like (S21). Note that the processing in S21 corresponds to (Procedure 1) of the graph analysis unit 24 in Example 1.

The graph processing unit 23 sets an arbitrary state input to the data input unit 21 by the system administrator 10 or the like as a target node (S22).

In order to bring the target node into the absorbing state, the graph processing unit 23 cuts an edge coming out from the target node (S23). The edge coming out from the target node is an edge whose arrow is directed from the target node to another node.

The graph processing unit 23 extracts only a path from the initial node to the target node (S24). Further, the graph processing unit 23 cuts all nodes and edges that are not included in the path extracted in S24.

The graph processing unit 23 calls the processing in FIG. 3 (S11 to S15) for the state transition diagram in which the edges have been cut in S24, thereby applying an appropriate parameter λ to all the edges (S25).

The graph processing unit 23 outputs a result of S25 to the graph analysis unit 24 as a state transition diagram (S26).

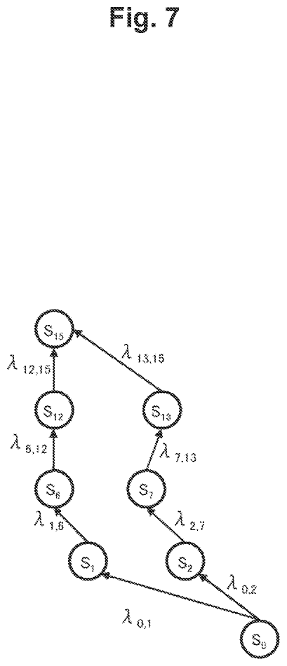

FIG. 7 is a graph showing an example of the state transition diagram generated by the processing in FIG. 6. The state transition diagram of FIG. 7, as well as the state transition diagram of FIG. 5, has a structure of nodes and links extracted from the BAG of FIG. 8. Meanwhile, in the state transition diagram of FIG. 7, some nodes and edges are cut from the state transition diagram of FIG. 5 as shown in S23 and S24. Therefore, the state transition diagram of FIG. 7 has the following features.

(Feature 1) All paths converge into the target node.

(Feature 2) The target node is in the absorbing state. In other words, a path once branched does not escape to another path that does not pass through the target node and is absorbed by the target node.

For example, the initial node in FIG. 7 corresponds to the state S₀, and the target node corresponds to the state S₁₅. That is, the graph processing unit 23 cuts all edges coming out from the state S₁₅, such as P_{15,17}, and extracts only paths from S₀ to S₁₅.

At this time, the state probability φ₁₅ (t) of the target node S₁₅ at the elapsed time t, which is calculated by the graph analysis unit 24, can be regarded as the probability of transitioning to the state S₁₅ before the time t (while allowing the attacker to simultaneously select a plurality of options).

### Effects

The risk evaluation device 20 of the present invention includes:
the BAG creation unit 22 that acquires a BAG that is a graph including, as components, a node indicating a state of a network system to be subjected to risk evaluation and an edge indicating a state transition by connecting the nodes and in which an exploit success probability that is a probability that an attacker succeeds in exploiting a vulnerability is applied to each edge;
the graph processing unit 23 that obtains a transition rate indicating a speed at which the attacker succeeds in exploiting the vulnerability by using the exploit success probability of the BAG and a limit time required for attacking the vulnerability and creates a state transition diagram of a continuous-time Markov chain that is a data structure including each node and each edge of the BAG and in which the obtained transition rate is applied to each edge instead of the exploit success probability of each edge;
the graph analysis unit 24 that calculates a risk probability of each node that changes with an elapsed time t from when the attacker has started the attack by performing a Markov analysis process on the basis of the state transition diagram created by the graph processing unit 23 and the elapsed time t; and the assessment result output unit 25 that outputs the calculated risk probability.

Therefore, the transition rate required for exploiting each vulnerability is added to the given BAG, and probabilistic dependencies between system states are described as a continuous-time Markov chain. By performing the Markov analysis process on the continuous-time Markov chain, it is possible to perform risk evaluation in consideration of a temporal change in a risk.

In the risk evaluation device 20 of the present invention, the graph analysis unit 24 further calculates an average time to transition to each state on the basis of the state transition diagram and an initial state probability vector indicating a set of state probabilities of the nodes at a point of time when the elapsed time t is 0; and
the assessment result output unit 25 further outputs the calculated average time.

Therefore, by knowing how the risk changes after the attack is started on the basis of the calculated average time, it is possible to flexibly perform risk treatment by, for example, dynamically changing priority of countermeasures.

In the risk evaluation device 20 of the present invention, in a step of creating the state transition diagram, the graph processing unit 23 sets a predetermined state of the input state transition diagram as a target node, cuts an edge coming out from the target node, and cuts a node and an edge that are not included in a path from an initial node in which a state probability is not 0 at a point of time when the elapsed time t is 0 to the target node.

Therefore, all branches from the initial node are aggregated into one target node, and thus a risk probability of the target node, which is similar to a risk probability in a case where all the branches to the target node are traced simultaneously in parallel, can be calculated with high accuracy.

### REFERENCE SIGNS LIST

10 System administrator
20 Risk evaluation device
21 Data input unit
22 BAG creation unit (BAG acquisition unit)
23 Graph processing unit
24 Graph analysis unit
25 Assessment result output unit (output unit)

1. A risk evaluation device comprising:
a BAG acquisition unit, including one or more processors, configured to acquire a BAG that is a graph including, as components, a node indicating a state of a network system to be subjected to risk evaluation and an edge indicating a state transition by connecting the nodes and in which an exploit success probability that is a probability that an attacker succeeds in exploiting a vulnerability is applied to each edge;
a graph processing unit, including one or more processors, configured to obtain a transition rate indicating a speed at which the attacker succeeds in exploiting the vulnerability by using the exploit success probability of the BAG and a limit time required for attacking the vulnerability and creates a state transition diagram of a continuous-time Markov chain that is a data structure including each node and each edge of the BAG and in which the obtained transition rate is applied to each edge instead of the exploit success probability of each edge;
a graph analysis unit, including one or more processors, configured to calculate a risk probability of each node that changes with an elapsed time from when the attacker has started the attack by performing a Markov analysis process based on the state transition diagram created by the graph processing unit and the elapsed time; and
an output unit, including one or more processors, configured to output the calculated risk probability.

2. The risk evaluation device according to claim 1, wherein:
the graph analysis unit is further configured to calculate an average time to transition to each state based on the state transition diagram and an initial state probability vector indicating a set of state probabilities of the nodes at a point of time when the elapsed time is 0; and
the output unit is further configured to output the calculated average time.

3. The risk evaluation device according to claim 1, wherein:
in creating the state transition diagram, the graph processing unit is configured to:
set a predetermined state of an input state transition diagram as a target node;
cut an edge coming out from the target node; and
cut a node and an edge that are not included in a path from an initial node in which a state probability is not 0 at a point of time when the elapsed time is 0 to the target node.

4. A risk evaluation method, the risk evaluation method comprises:
acquiring a BAG that is a graph including, as components, a node indicating a state of a network system to be subjected to risk evaluation and an edge indicating a state transition by connecting the nodes and in which an exploit success probability that is a probability that an attacker succeeds in exploiting a vulnerability is applied to each edge;
obtaining a transition rate indicating a speed at which the attacker succeeds in exploiting the vulnerability by using the exploit success probability of the BAG and a limit time required for attacking the vulnerability;
creating a state transition diagram of a continuous-time Markov chain that is a data structure including each node and each edge of the BAG and in which the obtained transition rate is applied to each edge instead of the exploit success probability of each edge;
calculating a risk probability of each node that changes with an elapsed time from when the attacker has started the attack by performing a Markov analysis process based on the state transition diagram and the elapsed time; and
outputting the calculated risk probability.

5. A non-transitory computer-readable medium storing software comprising instructions executable by one or more computers which, upon such execution, cause the one or more computers to perform operations comprising:
acquiring a BAG that is a graph including, as components, a node indicating a state of a network system to be subjected to risk evaluation and an edge indicating a state transition by connecting the nodes and in which an exploit success probability that is a probability that an attacker succeeds in exploiting a vulnerability is applied to each edge;
obtaining a transition rate indicating a speed at which the attacker succeeds in exploiting the vulnerability by using the exploit success probability of the BAG and a limit time required for attacking the vulnerability;
creating a state transition diagram of a continuous-time Markov chain that is a data structure including each node and each edge of the BAG and in which the obtained transition rate is applied to each edge instead of the exploit success probability of each edge;
calculating a risk probability of each node that changes with an elapsed time from when the attacker has started the attack by performing a Markov analysis process on the basis of the state transition diagram created by the graph processing unit and the elapsed time; and
outputting the calculated risk probability.
